(19) United States
(12) Patent Application Publication
(10) Pub. No.: US 2007/0237616 A1
(43) Pub. Date: Oct. 11, 2007

(54) Vehicle for transport of disabled persons situated in personal transport device

(76) Inventor: Jerry Maxwell, Mexico, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/401,556

(22) Filed: Apr. 11, 2006

(51) Int. Cl. B60P 1/04

(52) U.S. Cl. 414/475

(57) ABSTRACT

A vehicle for transport of an assistive transport device comprising a chassis with a plurality of wheels mounted to the chassis without transverse axles and a support platform operatively engaging with the chassis and being capable of raising and lowering. A lift assembly raises and lowers the platform. A hydrostatic drive assembly operatively connects to the plurality of wheels for driving the wheels. At least one controller operatively connects to the drive assembly and lift assembly for controlling movement of the transport vehicle.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The invention relates generally to a transport vehicle for carrying passengers and particularly a transport vehicle for transporting disabled persons situated in a personal transport device.

Physically disabled persons rely on various transport devices to aid their mobility, including wheelchairs and electric scooters. However, each type of transport device has its drawbacks. As a result, a physically disabled person may have to rely on multiple transport devices to accommodate specific situations. For example, wheelchairs and electric scooters work adequately in locations that have relatively smooth terrain, such as floors, sidewalks, ramps, and the like. However, they are not practical for covering irregular terrains, such as steps, trails, grassy or hilly areas, and the like. Therefore, the disabled person may need to be transferred among multiple transport devices to another to accommodate different terrains, such transfers usually require the assistance of one or more persons.

Accordingly, there remains a need for a transport device capable of handling irregular terrains, which a disabled person can load and unload from without the assistance of others.

### DESCRIPTION OF THE DRAWINGS

In the accompanying drawings which form part of the specification:

FIG. 1 is a perspective view of an embodiment of a transport vehicle in accordance with and embodying the present invention;

FIG. 2 is a side elevational view of the transport vehicle;

FIG. 3 is a front elevational view of the transport vehicle;

FIG. 4 is a front elevational view of the transport vehicle with a front gate in an open position;

FIG. 5 is a plan view of a chassis of the transport vehicle;

FIG. 6 is a front elevational view of the chassis of the transport vehicle;

FIG. 7 is a side elevational view of the support platform of the transport vehicle;

FIG. 8 is a front elevational view of the support platform with a front gate in an open position;

FIG. 9 is a side elevational view of the transport vehicle with the support platform in a raised position;

FIG. 10 is rear elevational view of the transport vehicle;

FIG. 11 is a schematic representation of a drive assembly and a safety assembly of the transport vehicle;

FIG. 12 is a bottom view of the chassis and the brake assembly of the transport vehicle;

FIG. 13 is a front elevational view of an alternate embodiment of a transport vehicle in accordance with and embodying the present invention with a front access panel in an open position.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

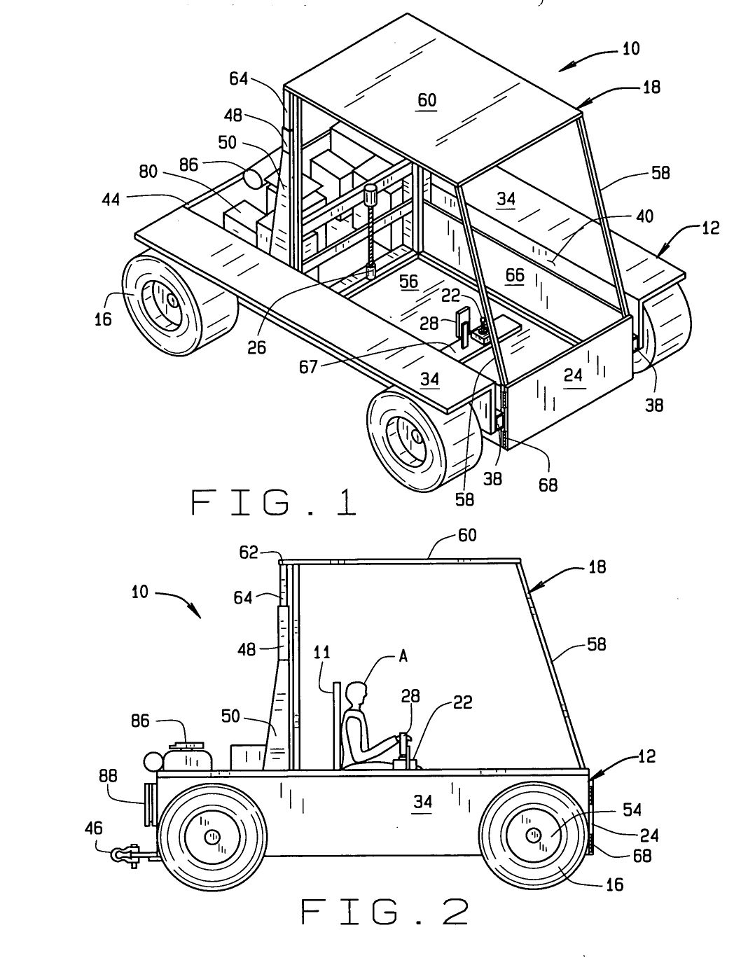

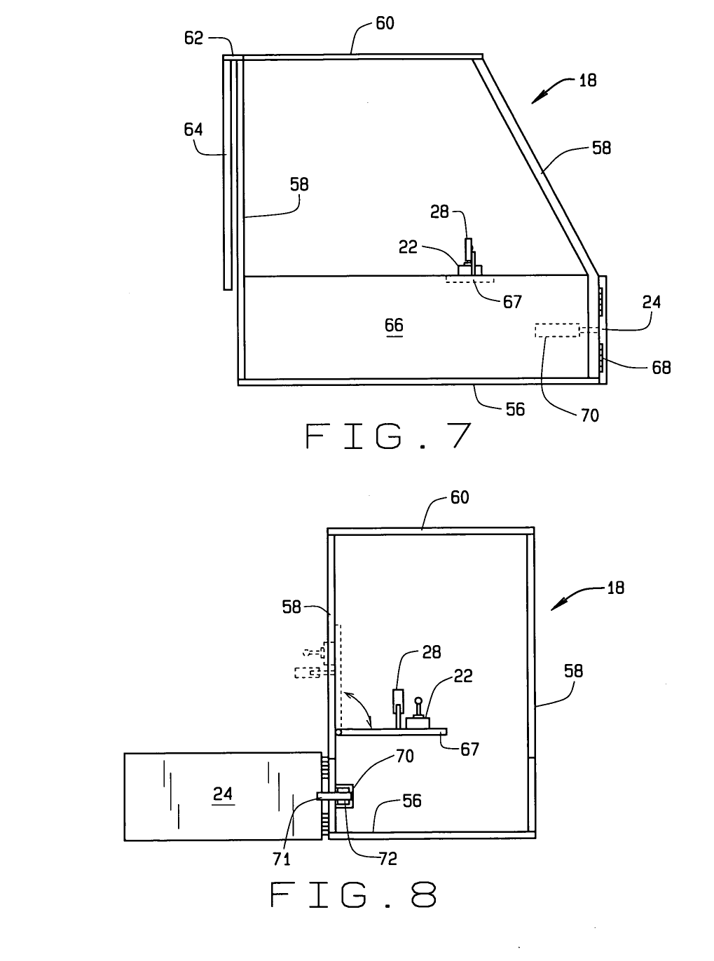

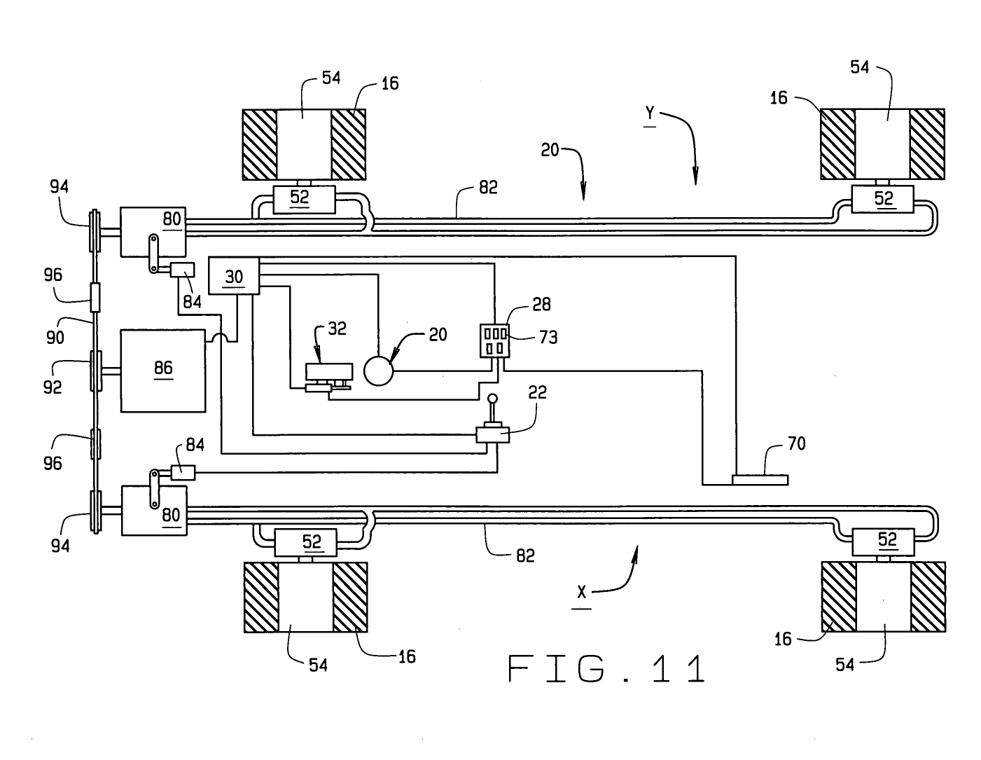

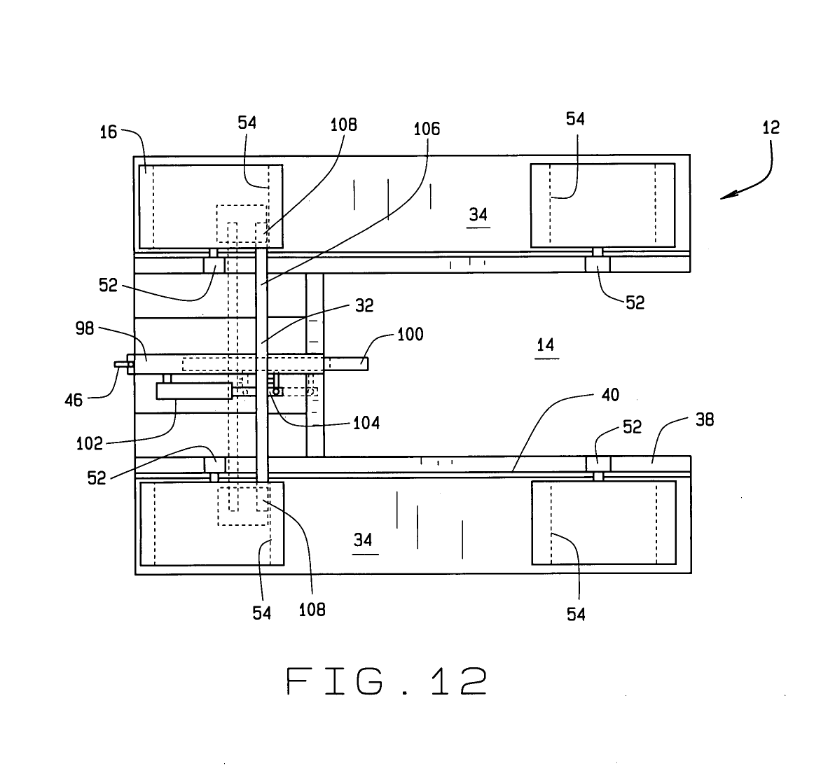

As shown in FIGS. 1-12, an illustrative embodiment of the present invention, generally referred to as a transport vehicle 10, includes a generally U-shaped chassis 12 (FIG. 5) having a central opening 14 and is supported by four wheels 16. The chassis 12 supports a moveable support platform 18 within the central opening 14. (The platform 18 is shown alone in FIGS. 7 and 8). The support platform 18 is adapted for supporting a physically disabled person “A” (FIG. 2) who is seated in a personal transport device 11, such as a wheelchair, powered scooter, or other similar devices. The movement of the vehicle 10 is powered and controlled by a drive assembly 20 (FIG. 11), which drives the wheels 16 independently without any transverse axles connecting them. The platform 18 can be raised and lowered by a lift assembly 26 connected to the chassis 12 and the support platform 18, allowing person “A” to be loaded onto and unloaded from the platform 18 at various heights through a hinged front gate 24. Person “A” operates the lift assembly 26 through a control board 28, which is operatively connected to a power source 30, such as a battery, preferably with about 1000 cranking amps. Once loaded onto the platform 18, person “A” controls the movement of the vehicle 10 through the use of a joystick controller 22, which is operatively connected to the drive assembly 20 and the power source 30. A brake assembly 32 (FIG. 12) is mounted to the underside of the chassis to engage and stop any movement of the wheels 16 and platform 18. The brake assembly 32 is operatively connected to the control board 28 and power source 30 to be operated manually. In addition, the brake assembly 32 is designed to operate automatically in the case of a failure of the drive assembly 24 or power source 30. Numerous such automatic braking systems are known to those of ordinary skill in the art.

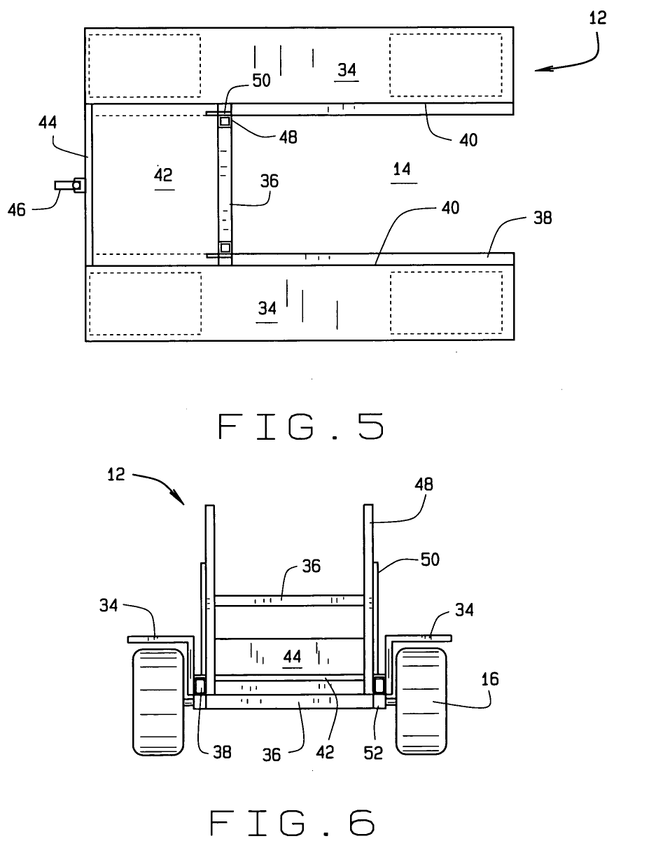

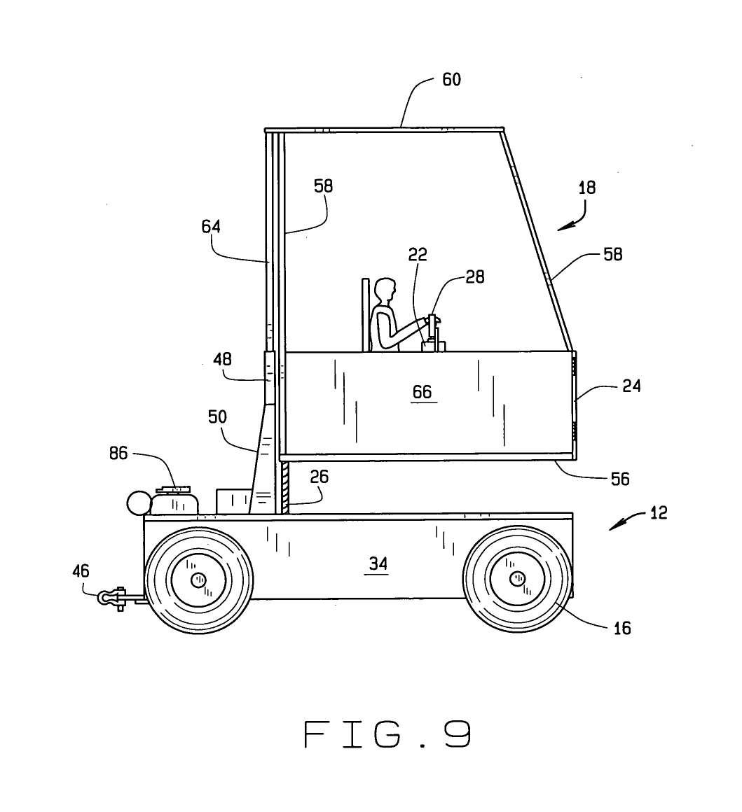

As shown in FIGS. 5-6, the chassis 12 includes two generally parallel and L-shaped side members 34 connected at their rear portions by cross members 36, thereby defining the central opening 14 between the side members 34. Support bars 38 attached horizontally along an inner face 40 of each side member 34 support a horizontal bed plate 42 and vertical rear gate 44 at the rear portion of the chassis 12. A hitch 46 is attached to the underside of the bed plate 42, which can be used for towing. Vertical guides 48 made from square hollow tubes extend vertically from the support bars 38 to engage and support the support platform 18 (FIG. 9). Gussets 50 (FIGS. 5 and 6) are attached between each guide 48 and the corresponding side member 34 to adequately brace the guides 48 for supporting the support platform 18. The wheels 16 are attached to the support bars 38 at the corners of the chassis 12 via hydrostatic motors 52, which are secured to the bottom of the support bars 38 by an appropriate means such as welding or fasteners. Each motor 52 attaches to a hub 54 (FIG. 12) of a respective wheel 16 and is driven by the drive assembly 20, which is discussed in further detail below.

As shown in FIGS. 7-8, the support platform 18 includes a base 56 with roof supports 58 extending generally vertically from each corner to support a roof 60. The roof 60 extends slightly past the two rear roof supports 58 to define an overhang 62. Square shafts 64 extend downwardly from each corner of the overhang 62 to slidably engage with the guides 48 of the chassis 12 (FIGS. 1 and 2). Side panels 66 span between the roof supports 58 to partially enclose the bottom portion of the platform 18. An arm 67 is pivotally attached to one of the side panels 66 with hinge 69 to support and position the joystick 22 and control board 26 in a location that is easily accessible by the operator when loaded on the support platform 18. The arm pivots between a generally horizontal position to locate the joystick 22 and control board 26 for operative engagement by the operator and a generally vertical position to provide access to the support platform for loading and unloading of person “A”.

To assemble the platform 18 within the chassis 12, the shafts 64 insert into the hollow guides 48 with a sliding fit so that the platform 18 can be raised and lowered along the guides 48 within the central opening 14 by the lift assembly 26 (FIG. 9). When assembled, the rear roof supports 58 rest along the outer faces of the guides 48 to support the cantilever forces from the weight of the platform 18. To reduce friction and promote smoother movement of the platform 18, the shafts 64 and guides 48 are lubricated with grease or any other suitable material known to those skilled in the art.

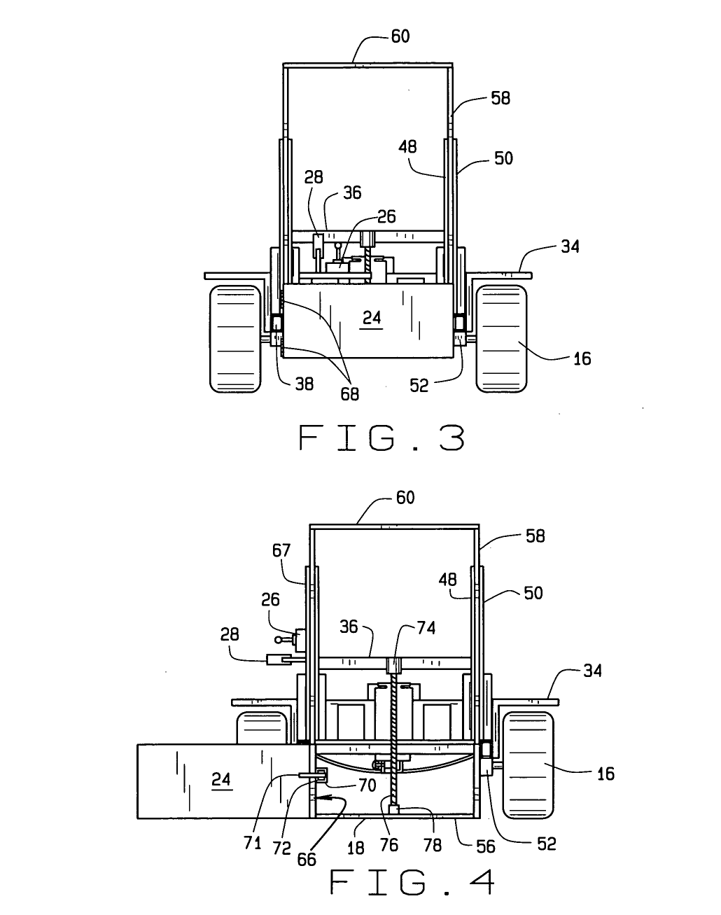

To further provide access to the support platform 18 for loading and unloading, the front gate 24 is pivotally attached across the front two roof supports 50 with hinges 68, as shown in FIGS. 3-4. An actuated cylinder 70 opens and closes the gate 24, which is removeably mounted to the side panel 66 and removeably coupled to a mount 71 on the inner face of the gate 24 with a pin 72. The cylinder 70 is operatively connected to the power source 30 and the control board 28. A corresponding toggle switch 73 on the control board 28 extends and retracts the cylinder 70, which respectively pivots the gate 24 between an open position (FIG. 4) and a closed (FIG. 3) position. In case of power failure, the pin 72 can be removed to disconnect the cylinder from the gate 24 so that the gate 24 can be operated manually.

In the preferred embodiment, both the chassis 12 and support platform 18 are constructed from a suitable material such as steel, and assembled using known construction methods, such as welding. However, those skilled in the art will recognize that any suitable material, such as aluminum or other metals, and construction method can be used, so long as the material is structurally and functionally capable of performing the features and functions of the invention described and illustrated herein.

As shown in FIGS. 1 and 3-4, the lift assembly 26 includes a stepper motor 74 with a lead screw 76 that is attached to the upper cross member 36 of the chassis 12. A lead nut 78 mounted to the base 56 of the support platform 18 engages the lead screw 76 so that the operation of the stepper motor 74 raises and lowers the platform 18. Specifically, as the stepper motor 74 rotates the lead screw 76 back and forth, the lead nut 78 correspondingly travels up and down the lead screw 76, thereby raising and lowering the support platform 18. As mentioned above, the lift assembly 26 is operatively connected to the power source 30 and the control board 28 so that the operator engages a corresponding toggle switch 72 on the control board 28 to operate the lead screw 76 and thereby remotely raise and lower the platform 18.

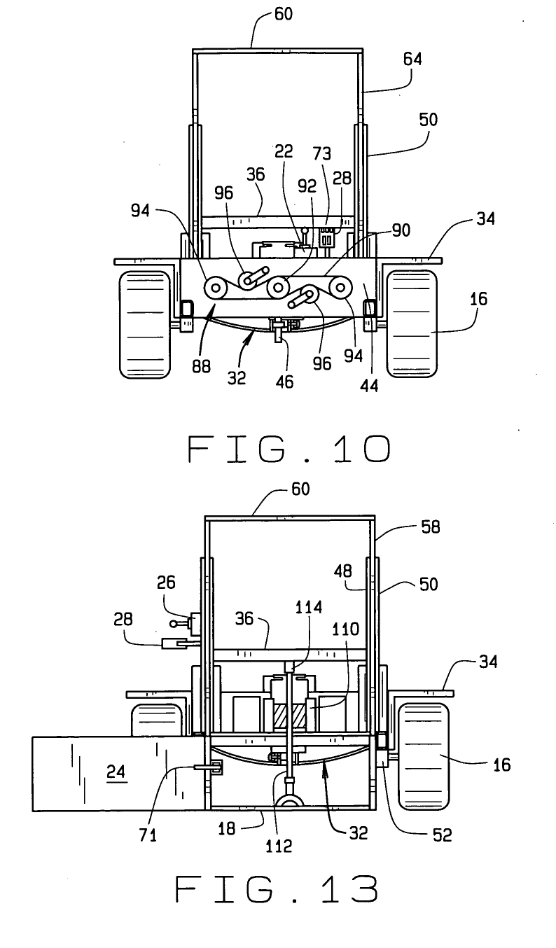

As shown in FIGS. 10-11, the depicted embodiment of the drive assembly 20 comprises a hydrostatic transmission for driving the wheels 16. The transmission includes a pair of hydrostatic pumps 80. Each pump 80 is operatively connected by hoses 82 to a respective pair of hydrostatic motors 52 located on respective first and second sides (X, Y) of the vehicle 10. The pumps 80 convey hydraulic fluid through the hoses 82 in both forward and reverse directions to drive the motors 52 and wheels 16 in respective forward or reverse directions. In addition, the pumps 80 convey hydraulic fluid at various flow rates so that the motors 52 and wheels 16 may be driven at various speeds. The joystick controller 22 is operatively connected to the pumps 80 through actuated cylinders 84 so that person “A” can remotely control the direction and speed of the hydraulic fluid from the platform 18 and thus, control the direction and speed of the vehicle 10 as further explained herein. The joystick 22 signals the cylinders 84 to incrementally extend and retract to adjust the performance of the pumps 80, and thereby incrementally adjust the performance of the wheels 16.

For example, moving the joystick 22 forward signals the cylinders 84 to extend so the pumps 80 convey hydraulic fluid to the motors 52 in the forward direction, thereby driving the vehicle 10 forward. To adjust the speed of the vehicle, the joystick 22 is moved in the desired direction of travel only incrementally, thereby adjusting the respective hydraulic fluid flow to the motors 52. To turn the vehicle, the joystick 22 will signal different flow rates of hydraulic fluid to each of the pumps 80. As a result, one pair of the wheels 16, for example the wheels 16 on side X of the vehicle 10, will turn at a different rate of speed than the other pair of wheels 16 on side Y, causing a turn. Alternatively, the joystick 22 can signal to have flow rates to each pump in opposite directions. As a result, one pair of wheels 16, for example the wheels 16 on side X of the vehicle 10, will turn in a forward direction, and the other pair of wheels on side Y will turn in a reverse direction, causing a turn.

A gas engine 86 supplies power to drive the pumps 80 with a drive belt assembly 88 mounted through the rear gate 44. The engine 86 is operatively connected to the power source 30 for electronic ignition. The drive belt assembly 88 includes a drive belt 90 engaged with a drive pulley 92 coupled to the crankshaft of the engine 82 and two driven pulleys 94 coupled to the crankshafts of the pumps 80. Tensioners 96 pivotally attach to the rear gate 44 and engage the drive belt 90 to maintain proper tension on the belt 90 and insure proper engagement with the pulleys 92 and 94 to minimize power loss through slippage.

The equipment used in the drive assembly 20 can be any type well known to those skilled in the art. The hydrostatic motors 52 and pumps 80 are preferably a Series CE motor, which are commercially available from White Drive Products, Inc. of Hopkinsville, Ky. The engine is preferably a Command Series 25HP gas engine with horizontal crankshaft, which is available from Kohler®, Inc. of Kohler, Wis. The joystick controller 22 is preferably an ultra-compact type MO joystick controller, which is available from J.R. Merritt Controls, Inc. of Stratford, Conn. Using this equipment, the vehicle is capable of towing approximately 10,000 lbs. and traveling at speeds of up to about 15 mph. Although, the depicted embodiment of the drive assembly 20 is four wheel drive, those skilled in the art will recognize that either a front or rear wheel drive can also be used.

In the depicted embodiment, the engine 82 and pumps 80 are mounted within the rear bed 36 to act as a counterweight to the support platform 18. In this way, when a person is loaded onto the platform the entire vehicle 10 remains relatively balanced and stabilized. However, those skilled in the art will recognize that the engine 82 and pump 80 can be mounted at other locations of the vehicle. If necessary, additional counterweights can be added at appropriate locations to balance the vehicle 10.

As shown in FIG. 12, the brake assembly 32 includes a hollow guide 98 mounted to the underside of the chassis 12. A shaft 100 slidably engages within the guide 98. An actuated cylinder 102 mounts to the outer surface of the guide 98 with a rod 104 that can extend and retract. The rod 104 attaches to the shaft 100 through a slot (not shown) in the guide 98 and also attaches to a brake rod 106, which extends into both rear wheel hubs 54 to engage drum brakes 108. When the cylinder 102 extends, the brake rod 106 moves forward so that the drum brakes 108 disengage from the rear wheel hubs 54. In addition, the shaft 100 simultaneously extends forward so that the platform 18 can not be lowered when the brake assembly 32 is being activated. When the cylinder 102 retracts, the brake rod 106 moves rearward so that the drum brakes 108 engage an inner surface of the rear wheel hubs 54 and, thereby, brake the rear wheels 16. In addition, the shaft 100 simultaneously retracts within the guide 98 so that the platform 18 can be lowered. The cylinder 102 operatively connects to the power source 30 and a corresponding toggle switch 73 on the control board 28 for remote control of the brake assembly 32 by person “A” within the platform 18. In addition, a failure of the drive assembly 20 will automatically activate the cylinder 102 to retract and brake the vehicle 10. Of course, those skilled in the art will recognize that any type of brake system, such as disc brakes, can be used to in place of the brake assembly 32 described above for braking the vehicle 10.

Changes can be made in the above constructions without departing from the scope of the invention. It is intended that all matter contained in the above description or shown in the accompanying drawings shall be interpreted as illustrative and not in a limiting sense.

For example, an alternate embodiment of the invention (FIG. 13) can use a winch assembly 109 in place of the stepper motor 74 and lead screw 76. The winch assembly 109 includes a winch 110 and cable 112 attached to the base 56 of the platform 18. The cable threads through a pulley 114, which is mounted to the cross member 36 and terminates at the winch 110. One of ordinary skill in the art will recognize that rotation of the winch 110 in one direction will raise the platform 18 while rotating of the winch 110 in the opposite direction will allow the platform 18 to lower.

In another alternate embodiment, an electric power source can be used in place of the combustion engine 86 to power the drive assembly 20. In yet another alternate embodiment, the guides 48 can support the shafts with bearings. In yet another embodiment, the battery 30 can be operatively connected to the engine 86 through an alternator, which recharges the battery 30.

What is claimed is:

1. A vehicle for transport of an assistive transport device comprising:
a chassis;
a support platform operatively engaged with the chassis for supporting the assistive transport device and being capable of raising and lowering the assistive transport device for loading and unloading at different heights;
a lift assembly operatively connected to the platform and capable of raising and lowering the platform;
a plurality of wheels mounted to the chassis without transverse axles connecting the wheels;
a drive assembly operatively connected to one of said plurality of wheels for driving the wheels; and
a controller operatively connected to the drive assembly for controlling movement of the vehicle and operatively connected to the lift assembly for controlling movement of the platform.

2. The vehicle of claim 1, wherein the drive assembly comprises a hydrostatic motor capable of operative engagement with the plurality of wheels.

3. The vehicle of claim 2, wherein the drive assembly further comprises a hydrostatic pump operatively connected to the hydrostatic motor.

4. The vehicle of claim 3, further comprising an engine capable of powering the hydrostatic pump.

5. The vehicle of claim 4, wherein the drive assembly comprises a drive belt system capable of coupling the engine to the hydrostatic pump, the drive belt system having:
a drive pulley associated with the engine;
a driven pulley associated with the hydrostatic pump;
a belt associated with both the drive pulley and driven pulley, the belt being capable of transferring power from the engine to the hydrostatic pump.

6. The vehicle of claim 1, wherein the controller comprises:
a first controller operatively connected to the drive assembly for controlling movement of the vehicle; and
a second controller operatively connected to the lift assembly for controlling movement of the platform.

7. The vehicle of claim 1, wherein:
a first of said plurality of wheels is positioned on a first side of the vehicle;
a second of said plurality of wheels is positioned on a second side of the vehicle; and
the drive assembly is capable of independent operative engagement with each of said first and second of said plurality of wheels;
such that when the drive assembly operatively engages the first of said plurality of wheels to rotate said first wheel at a rate faster than the rate at which the second of said plurality of wheels is rotating, the vehicle will turn in a first direction, and when the drive assembly operatively engages the second of said plurality of wheels to rotate said second wheel at a rate faster than the rate at which the first of said plurality of wheels is rotating, the vehicle will turn in a second direction different from the first direction.

8. The vehicle of claim 7, wherein the drive assembly comprises a first hydrostatic system capable of operative association with the first of said plurality of wheels, and a second hydrostatic system capable of operative association with the second of said plurality of wheels; and
the first and second hydrostatic systems are controlled by the first controller.

9. The vehicle of claim 7, wherein the support platform is positioned between the first side and the second side.

10. The vehicle of claim 1, wherein the drive assembly comprises a drive belt system.

11. The vehicle of claim 10, wherein the drive belt system has:
a stepper motor associated with the chassis;
a lead screw attached to the stepper motor so that the stepper motor is capable of bi-directionally rotating the lead screw axially; and
a lead nut attached to the support platform and engaged with the lead screw so that the lead nut travels up and down the lead screw as the lead screw rotates.

12. The vehicle of claim 1, wherein the lift assembly comprises a winch.

13. The vehicle of claim 12, wherein the winch has a cable coupled with the support platform; and
a pulley mounted to the chassis and engaged with the cable;
such that the cable is capable of raising and lowering the platform in the general direction of the pulley upon activation of the winch.

14. The vehicle of claim 1, wherein the support platform comprises a gate capable of opening to provide access to the platform and closing to restrict access to the platform.

15. The vehicle of claim 14, wherein the support platform further comprises an actuation device engaged with the gate, the actuation device being capable of opening and closing the gate.

16. The vehicle of claim 15, wherein the actuation device is remotely controlled.

17. The vehicle of claim 16, wherein the actuation device is remotely controlled by one of the two vehicle controllers.

18. The vehicle of claim 15, wherein the actuation device comprises a pneumatic cylinder.

19. The vehicle of claim 15, wherein the actuation device comprises a hydraulic cylinder.

20. The vehicle of claim 1, further comprising a brake assembly operatively associated with one of the plurality of wheels, such that the brake assembly is capable of braking and releasing said wheel.

21. The vehicle of claim 20, wherein the brake assembly comprises:
a brake capable of engaging the wheel; and
an actuation device associated with the brake;
wherein the actuation device is capable of actuating the brake to engage and thereby slow the wheel.

22. The vehicle of claim 20 wherein the brake assembly comprises:
a guide mounted to the chassis;
a shaft slidably engaged within the guide;
a cylinder mounted to the guide and engaged with the shaft;
wherein the cylinder extends and retracts the shaft to respectively engage and disengage the support platform.

23. A vehicle for transport of an assistive transport device comprising:
a chassis;
a plurality of wheels independently mounted to the chassis without transverse axles connecting the wheels;
a support platform operatively engaged with the chassis and positioned between at least two of said plurality of wheel, the platform being capable of supporting the assistive transport device;
a lift assembly associated with the platform, the lift assembly being capable of raising and lowering the platform and assistive transport device thereon, for loading and unloading of the assistive transport device at more than one height;
a drive assembly operatively connected to the plurality of wheels for driving the wheels; and
a controller associated with the drive assembly for controlling movement of the vehicle.

24. A method of transporting an assistive transport device with a vehicle, the method comprising:
providing a chassis;
providing a support platform operatively engaged with the chassis;
supporting the assistive transport device with the platform;
providing a lift assembly operatively connected to the platform;
raising and lowering the lift assembly to load and unload the assistive transport device at different heights;
providing a plurality of wheels mounted to the chassis without transverse axles connecting the wheels;
providing a drive assembly operatively connected to the plurality of wheels; and
driving the wheels with the drive assembly.

25. The method of claim 24, further comprising:
providing a controller operatively connected to the drive assembly; and
controlling movement of the vehicle with the controller; and
controlling movement of the platform with the controller.

26. The method of claim 24, further comprising:
positioning a first of said plurality of wheels on a first side of the chassis;
positioning a second of said plurality of wheels on a second side of the chassis; and
selectively rotating the first of said plurality of wheels at a rate faster than the rate at which the second of said plurality of wheels is rotating so that the vehicle turns in a first direction.

27. The method of claim 26, further comprising further comprising:
rotating the second of said plurality of wheels at a rate faster than the rate at which the first of said plurality of wheels is rotating so that the vehicle controllably turns in a second direction different from the first direction.

28. The method of claim 24, further comprising:
providing a brake assembly operatively associated with one of the plurality of wheels;
selectively braking of said wheel with the brake assembly to controllably slow the vehicle.

29. A vehicle for transport of an assistive transport device comprising:
a chassis;
a support platform operatively engaged with the chassis for supporting the assistive transport device and being capable of raising and lowering the assistive transport device for loading and unloading at different heights;
a means for raising and lowering the support platform;
a plurality of wheels mounted to the chassis without transverse axles connecting the wheels;
a means for driving the plurality of wheels; and
a means for controlling movement of the vehicle for controlling movement of the platform.
